(19) United States
(12) Patent Application Publication
(10) Pub. No.: US 2009/0016449 A1
(43) Pub. Date: Jan. 15, 2009

(54) Providing placement information to a user of a video stream of content to be overlaid

(76) Inventors: Gene Cheung, Palo Alto, CA (US); Wai-tian Tan, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/827,509

(22) Filed: Jul. 11, 2007

(51) Int. Cl. H04N 11/04

(52) U.S. Cl. 375/240.29

(57) ABSTRACT

Providing placement information for content to be overlaid on a video stream. A video stream is received which comprises subject matter. A value corresponding to the subject matter in the video stream is received. The value is coupled with the video stream such that the value can be utilized to generate placement information for the content to be overlaid on the video stream.

### BACKGROUND

Video streams are created for a variety of reasons: for conveying information, such as a news broadcast; for educational purposes, such as a how-to program or documentary; or for entertainment, such as a sporting event, game show, or streaming video game. In general, the creator of a video stream is concerned primarily with the content and appearance of the material comprising the video stream. Once the video stream is distributed to a distributor, e.g. broadcasting station for TV content, the distributor decides how the video stream will be used and displayed by itself or in combination with other video content of interest.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A is an example of an image produced from video stream, upon which embodiments of the present invention can be practiced.

FIG. 1B illustrates regions of importance within a video stream, in accordance with an embodiment of the present invention.

FIG. 1C is an image produced from a video stream having overlaid content placed appropriately, in accordance with an embodiment of the present invention.

FIG. 2A is an example of an image produced from a video stream, upon which embodiments of the present invention can be practiced.

FIG. 2B are regions of importance of a video stream, in accordance with an embodiment of the present invention.

FIG. 2C is an image produced from a video stream, in accordance with an embodiment of the present invention.

FIG. 3 is a flow chart illustrating a process for providing placement information for content to be overlaid on a video stream, in accordance with an embodiment of the present invention.

FIG. 4 is a flow chart illustrating a process for providing placement information for content to be overlaid on a video stream, in accordance with an embodiment of the present invention.

FIG. 5 is block diagram illustrating a system for providing placement information for content to be overlaid on a video stream, in accordance with an embodiment of the present invention.

The drawings referred to in this description should not be understood as being drawn to scale except if specifically noted.

### DESCRIPTION OF THE EMBODIMENTS

Various embodiments of the present invention, providing placement information for content to be overlaid in a video stream, are described herein. In one embodiment, a video stream is received which comprises subject matter. A value corresponding to the subject matter in the video stream is received. The value is coupled with the video stream such that the value can be utilized to generate placement information for the content to be overlaid on the video stream.

Reference will now be made in detail to the various embodiments of the invention, examples of which are illustrated in the accompanying drawings. While the invention will be described in conjunction with the various embodiments, it will be understood that they are not intended to limit the invention to these embodiments. On the contrary, embodiments of the invention are intended to cover alternatives, modifications and equivalents, which may be included within the spirit and scope of the invention as defined by the appended claims. Furthermore, in the following description of the various embodiments of the present invention, numerous specific details are set forth in order to provide a thorough understanding of embodiments of the present invention. In other instances, well known methods, procedures, and components have not been described in detail as not to unnecessarily obscure aspects of the embodiments of the present invention.

Communication using video is pervasive in modern culture. Video is sent into homes for entertainment, to provide information, and for marketing products. The subject matter of video can be very broad and varies in importance both to the creator of the subject matter as well as to the viewing audience, the consumers of the subject matter. It is desirable to both the creators and receivers that the importance of the subject matter is not obscured or lost when it is received.

Generally, different parties are involved in the creation, distribution, and consumption of video content. For example, in the context of broadcast video television (TV), video content can be created by a studio e.g., Disney, and be distributed by a local broadcasting station e.g., Channel 7, and be consumed by individuals. There is a potential for having the importance of the subject matter obscured by a distributor e.g. local broadcast station, when the local broadcast station wishes to add local content information to a video stream. One method used to avoid the obscuring of subject matter by a local broadcast station is to temporally identify locations in the video stream wherein local content information may be inserted. Temporal identification is conducive to inserting advertisements or announcements of local interest by a broadcaster of video content. With temporal identification, a broadcaster knows where in the video stream that the subject matter begins and ends or where the subject matter resumes or pauses.

A local broadcast station may have content to be overlaid, which is germane to the populous they serve. Content to be overlaid can be as varied as the different communities. Examples of content to be overlaid are: subtitles for a local language; local news; upcoming social and community events; local sponsorship of the broadcast; and an announcement of an upcoming broadcast program.

A broadcaster can further enrich both the entertainment and commercial value of video content by video-based operations such as, picture-in-picture overlay, content blending, animated logo and subtitle insertion. These operations allow customization of content for different targeted audiences. It would be challenging to have the original content creator/owner create a large number of enhanced versions of the content, each tailored specifically for a target group. A more scalable approach is for content distributors e.g. local broadcast stations, to perform any customization that they may need using a customization engine. A customization engine is a means by which a content distributor can overlay content of local interest onto an image produced by a video stream.

Embodiments of the present invention address the issue of ensuring that important parts of subject matter in a video stream are not inadvertently obscured or modified by a customization engine, which is overlaying content of local interest. An entity controlling content creation and subject matter, e.g. a studio, may be different from the entity performing content overlaying, e.g. a TV broadcast station. It is important for the content creator or owner to be assured that important regions in the video stream will not be obscured or modified thus lowering the intrinsic value of the content. No matter what other video operations are subsequently performed the importance of the subject matter in the video stream should not be obscured or modified.

Embodiments of the present invention present a spatial annotation system where special regions of operations (SRO) and associated operators can be defined, so that only the permissible regions and permissible operations can be performed by a customization engine. The annotations can be either embedded inside the encoded video stream, appended to the video stream, or they can be sent/stored separately in, for example, a meta-data stream e.g., using MPEG-7.

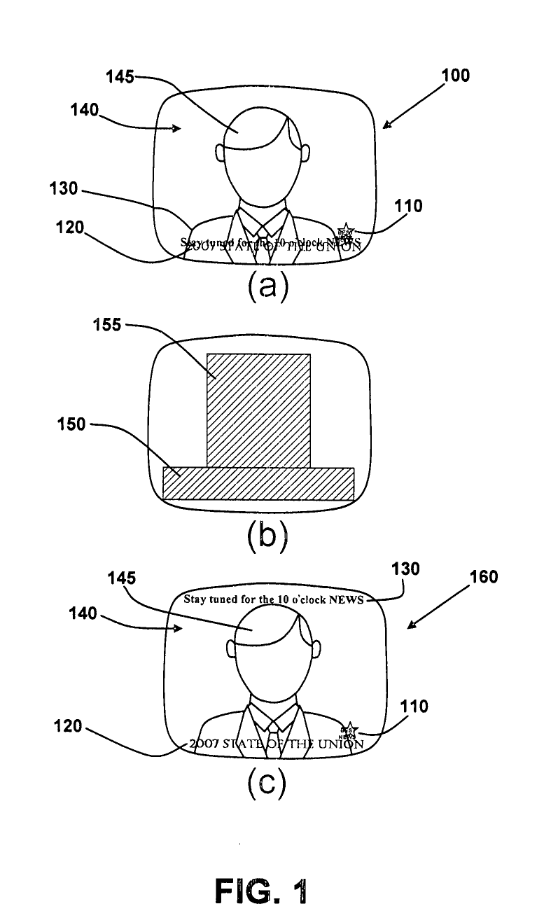

FIG. 1A illustrates an example of image 100 produced from a video stream, upon which embodiments of the present invention can be practiced. Image 100 comprises network video content 140 in which a customization engine has placed in the video stream which produces image 100, a logo 110, and caption 120 pertaining to the subject matter in image 100. In exemplary broadcast video stream image 100, caption 120 for the subject matter is “2007 State of the Union.” The subject matter that a content creator has deemed important and having value is talking head 145, caption 120, and logo 110. It is in the best interest of the distributor, and the creator of the image of talking head 145 that the subject matter be broadcast clearly without change or obstruction. A TV broadcast station has overlaid content 130 on the video stream such that when displayed with broadcast video stream image 100, logo 110 and caption 120 are inadvertently obscured by content 130. The overlaid content 130 reads “Stay tuned for the 10 o'clock NEWS”.

FIG. 1B presents regions of importance (150, 155) of a video stream, in accordance with an embodiment of the present invention. Region of importance 155 approximately coincides with talking head 145 in broadcast video stream image 100. Region of importance 150 approximately coincides with caption 120 and logo 110. Regions of importance (150, 155) of a broadcast video stream are coupled to the video stream which produces broadcast video stream image 100. A broadcast station can use the value associated with the subject matter to place overlaid content 130 in a region outside regions of importance (150, 155) and thus prevent obscuring, modifying or interfering with logo 110, caption 120, or talking head 145.

Regions of importance (150, 155) have similar value, indicated by similar hatch patterns. In accordance with an embodiment of the present invention, the value of regions of importance (150, 155) is coupled with the video stream which produces broadcast video stream image 100. An importance metric of regions of importance (150, 155) related to their value is assigned prior to transmitting the video stream associated with broadcast video stream image 100. In accordance with one embodiment, the importance metric which is related to the value of regions of importance (150, 155) of the subject matter in the video stream is embedded in the video stream which produces broadcast video stream image 100. In accordance with another embodiment, a meta-data stream containing the importance metric, which is related to the value corresponding to regions of importance (150, 155) of the subject matter in the video stream, is sent to a broadcaster of the video stream, which produces broadcast video stream image 100.

FIG. 1C presents image 160 produced from a video stream, in accordance with an embodiment of the present invention. Image 160 comprises image 100, and content 130 overlaid so as not to obstruct the subject matter contained in image 100 produced from a video stream. The importance metric related to regions of importance (150, 155) in FIG. 1B has been utilized to generate placement information for overlaying content 130 in the video stream such that content 130 is displayed and does not obscure the subject matter comprising logo 110, caption 120, and talking head 145.

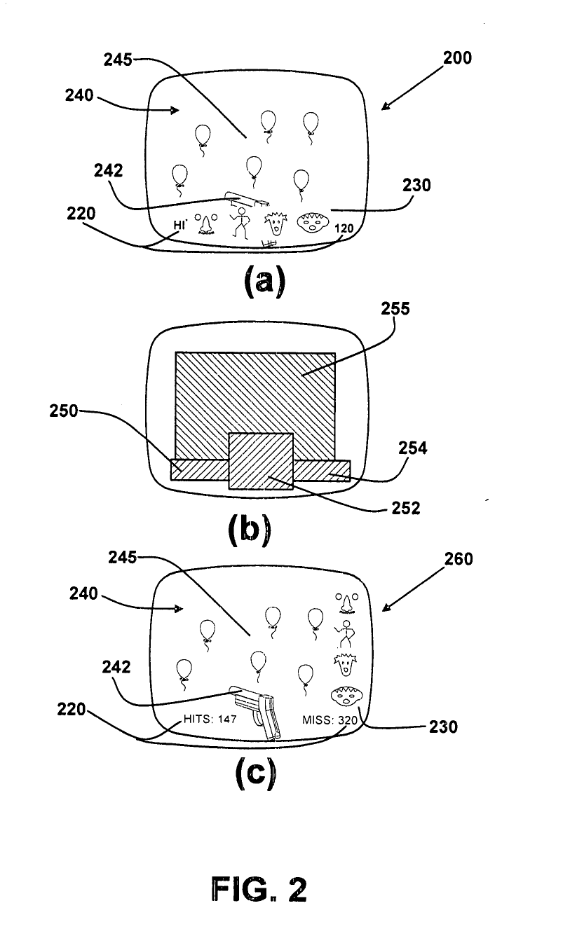

FIG. 2A illustrates an example of image 200 produced from a video stream, upon which embodiments of the present invention can be practiced. Image 200 comprises video gaming content 240, in which a video game provider has placed interactive device 242, target field 245 of interactive device 242, and score 220. Interactive device 242 in this example is a pistol. Target field 245 of the interactive device 245, in this example is a field of floating balloons. Score 220 pertains to the video gaming content 240 in broadcast video stream image 200. The subject matter that the video game provider has deemed important and having value is interactive device 242, target field 245, and score 220. It is in the best interest of the video gaming content provider and the video gaming content user that the subject matter be presented clearly without change or obstruction.

A new trend in the video game industry is to broadcast a video game with at least one player, to an audience of observers. To enhance the enjoyment of video game content 240 for the player and the audience, a broadcaster can allow a member of the audience to participate as an active observer by overlaying content 230 within broadcast video stream image 200. In the example presented in FIG. 2A, content 230 is an avatar. An avatar can be controlled by a member of the audience to be participatory with actions such as, jeering with audible sounds, words, pop-up comments, gestures, and animated movements.

In the example illustrated in FIG. 2A, overlaid content 230 is a group of four “hecklers.” A broadcast station has overlaid content 230 on the video stream such that when displayed with broadcast video stream image 200, interactive device 242, and score 220 are inadvertently obscured by content 230.

FIG. 2B presents regions of importance (250, 252, 254, 255) of a video stream, in accordance with an embodiment of the present invention. Region of importance (250, 254) approximately coincide with score 220 in broadcast video stream image 200. Region of importance 252 approximately coincides with interactive device 242. Region of importance 255 approximately coincides with target field 245. In the current example regions of importance (250, 252, 254, 255) of a broadcast video stream are coupled to the video stream which produces broadcast video stream image 200. A broadcast station can use the value associated with the subject matter to place overlaid content 230 in a region outside regions of importance (250, 252, 254, 255) and thus prevent obscuring, modifying or interfering with interactive device 242, target field 245, and score 220.

Regions of importance (250, 252, 254) have similar value, indicated by similar hatch patterns. Region of importance 255 has a value different from regions of importance (250, 252, 254). An example of a difference in value is a value which allows an avatar in content 230 to have occasional encroachment onto region of importance 255 since the position of balloons in target field 245 is transitory. Another example of a difference in value is a value which allows an avatar in content 230 to be overlaid transparently onto region of importance 255 since the balloons in target field 245 can be visible through a transparent avatar.

In accordance with an embodiment of the present invention, the value of regions of importance (250, 252, 254, 255) is coupled with the video stream which produces broadcast video stream image 200. An importance metric of regions of importance (250, 252, 254, 255) related to their value is assigned prior to transmitting the video stream associated with broadcast video stream image 200. In accordance with one embodiment, the importance metric, which is related to the value of regions of importance (250, 252, 254, 255) of the subject matter in the video stream is embedded in the video stream which produces broadcast video stream image 200. In accordance with another embodiment, a meta-data stream containing the importance metric, which is related to the value corresponding to regions of importance (250, 252, 254, 255) of the subject matter in the video stream, is sent to a broadcaster of the video stream, which will produce broadcast video stream image 200.

FIG. 2C presents image 260 produced from a video stream, in accordance with an embodiment of the present invention. The importance metric related to regions of importance (250, 252, 254, 255) in FIG. 2B has been utilized to generate placement information for overlaying content 230 in the video stream such that content 230 is displayed and does not obscure the subject matter comprising interactive device 242, target field 245, and score 220.

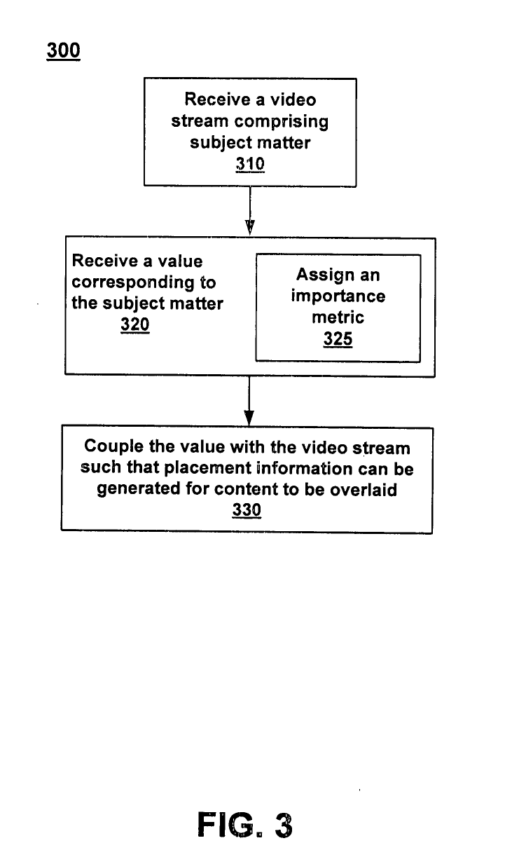

FIG. 3 is a flow chart illustrating a process 300 for providing placement information for content to be overlaid on a video stream, in accordance with an embodiment of the present invention. In one embodiment, process 300 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific components are disclosed in process 300, such components are exemplary. That is, the embodiments of the present invention are well suited to performing various other components or variations of the components recited in FIG. 3. Within the present embodiment, it should be appreciated that the components of process 300 may be performed by software, by hardware, by an assembly mechanism, through human interaction, or by any combination of software, hardware, assembly mechanism, and human interaction.

Process 300 will be described with reference to elements shown in FIG. 1A, FIG. 1C, FIG. 2A, FIG. 2B, and FIG. 2C.

In one embodiment, as shown at 310 of process 300 a video stream comprising subject matter is received. In accordance with an embodiment of the present invention and FIG. 1A, subject matter 140 comprising a video stream which produces image 100 comprises network video content. In accordance with an embodiment of the present invention and FIG. 2A, subject matter 240 comprising a video stream which produces image 200 comprises video gaming content. In accordance with an embodiment of the present invention and FIG. 1A, receiving a video stream which produces image 100 comprises receiving network video content. In accordance with an embodiment of the present invention and FIG. 2A, receiving a video stream which produces image 200 comprises receiving video gaming content.

In one embodiment, as shown at 320 of process 300 a value corresponding to the subject matter in the video stream is received.

In another embodiment as shown at 325 of process 300, receiving the subject matter further comprises assigning an importance metric to at least one region in the video stream that is related to the value corresponding to the subject matter. As an example and with reference to FIG. 2B, regions of importance (250, 252, 254) have similar value, indicated by similar hatch patterns. Region of importance 255 has a value different from regions of importance (250, 252, 254).

Value is determined by several different means. Examples of determining high value and assigning an appropriate importance metric are as follows: The color green can be given a high value of importance for a tennis match since this infers where that action of the tennis match is occurring. The convergence or resolution of pixels can infer the focus of a subject matter and region of importance of the subject matter in a video content. The central region in image 100 produced by a video stream, infers that the region of highest importance is at the center of image 100 produced by a video stream. Once high value is determined an appropriate importance metric can be assigned, for example, no overlaying of content is allowed in this region of highest importance.

Special regions of operations (SRO) and associated operators are inferred by the value determined above. A region not valued as a region of highest importance by the above exemplary means is an SRO that is assigned an importance metric whereby special operators are allowed. Examples of importance metrics whereby special operators are allowed are: allowing subtitles for a local language; allowing local news; allowing upcoming social and community events; allowing local sponsorship of the broadcast; and allowing an announcement of an upcoming broadcast program. Examples of special operators being allowed by importance metrics are exemplified by content 130 in FIG. 1C, and “hecklers” as exemplified by content 230 in FIG. 2C. In the example of video gaming content in FIG. 2C, and in accordance with an embodiment of the present invention, an SRO is defined by the creator of the video gaming content.

Any of the above examples can be controlled by an importance metric that defines the appearance of content (130, 230) to be overlaid. For example an importance metric can allow content (130, 230) to be overlaid in a region of importance as opaque content, if the importance metric is related to a region of importance with low value to the subject matter. An importance metric, which is related to a region of importance with medium value to the subject matter, can allow content (130, 230) to be overlaid in the region of importance as transparent content. As previously presented above, an importance metric can prevent any content (130, 230) to be overlaid in a region of importance, if the importance metric is related to a region of importance with high value to the subject matter.

In one embodiment, as shown at 330 of process 300 and in FIG. 1C and FIG. 2C, a value is coupled to a video stream such that the value can be utilized to generate placement information for content (130, 230) to be overlaid on the video stream which produces image (160, 260). In accordance with an embodiment of the present invention, the value is coupled to the video stream by embedding an importance metric, which is related to a value corresponding to the subject matter in a video stream. In accordance with another embodiment of the present invention, the value is coupled to the video stream by coupling a meta-data stream containing an importance metric, which is related to a value corresponding to the subject matter, to a video stream.

In one embodiment, as shown and in FIG. 1C and FIG. 2C, placement information for content to be overlaid on a video stream is provided. In accordance with another embodiment of the present invention, an importance metric is used to place content (130, 230) on a video stream which produces image (160, 260). Content (130, 230) is displayed in image (160, 260), produced by a video stream, in accordance with generated placement information and an importance metric, which is related to a value corresponding to the subject matter in a video stream. A method for providing placement information for content to be overlaid on a video stream is complete.

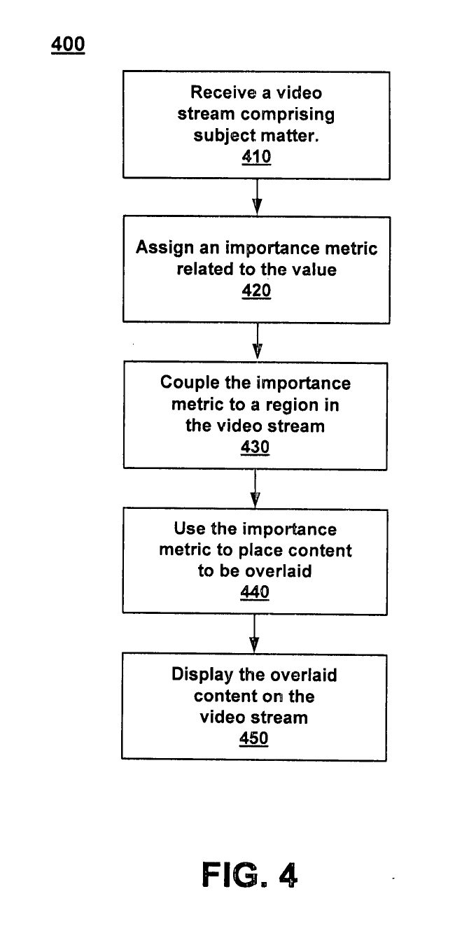

FIG. 4 is a flow chart illustrating a process 400 for providing placement information for content to be overlaid on a video stream, in accordance with an embodiment of the present invention. In one embodiment, process 400 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific components are disclosed in process 400, such components are exemplary. That is, the embodiments of the present invention are well suited to performing various other components or variations of the components recited in FIG. 4. Within the present embodiment, it should be appreciated that the components of process 400 may be performed by software, by hardware, by an assembly mechanism, through human interaction, or by any combination of software, hardware, assembly mechanism, and human interaction.

Process 400 will be described with reference to elements shown in FIG. 1A, FIG. 1C, FIG. 2A, FIG. 2B, and FIG. 2C.

In one embodiment, as shown at 410 of process 400 a video stream comprising subject matter is received. In accordance with an embodiment of the present invention and FIG. 1A, subject matter 140 comprising a video stream which produces image 100 comprises network video content. In accordance with an embodiment of the present invention and FIG. 2A, subject matter 240 comprising a video stream which produces image 200 comprises video gaming content. In accordance with an embodiment of the present invention and FIG. 1A, receiving a video stream which produces image 100 comprises receiving network video content. In accordance with an embodiment of the present invention and FIG. 2A, receiving a video stream which produces image 200 comprises receiving video gaming content.

In one embodiment, as shown at 420 of process 400, an importance metric, which is related to the value corresponding to the subject matter, is assigned to at least one region in the video stream. As an example and with reference to FIG. 2B, regions of importance (250, 252, 254) have similar value, indicated by similar hatch patterns. Region of importance 255 has a value different from regions of importance (250, 252, 254). In accordance with an embodiment of the present invention assigning an importance metric of at least one region in a video stream with regards to a value of a subject matter, comprises assigning an importance metric to some block of frames of the video stream.

Value is determined by several different means. Examples of determining high value and assigning an appropriate importance metric are as follows: The color green can be given a high value of importance for a tennis match since this infers where that action of the tennis match is occurring. The convergence or resolution of pixels can infer the focus of a subject matter and region of importance of the subject matter in a video content. The central region in image 100 produced by a video stream, infers that the region of highest importance is at the center of image 100 produced by a video stream. Once high value is determined an appropriate importance metric can be assigned, for example, no overlaying of content is allowed in this region of highest importance.

Special regions of operations (SRO) and associated operators are inferred by the value determined above. A region not valued as a region of highest importance by the above exemplary means is an SRO that is assigned an importance metric whereby special operators are allowed. Examples of importance metrics whereby special operators are allowed are: allowing subtitles for a local language; allowing local news; allowing upcoming social and community events; allowing local sponsorship of the broadcast; and allowing an announcement of an upcoming broadcast program. Examples of special operators being allowed by importance metrics are exemplified by content 130 in FIG. 1C, and “hecklers” as exemplified by content 230 in FIG. 2C. In the example of video gaming content in FIG. 2C, and in accordance with an embodiment of the present invention, an SRO is defined by the creator of the video gaming content.

Any of the above examples can be controlled by an importance metric that defines the appearance of content (130, 230) to be overlaid. For example an importance metric can allow content (130, 230) to be overlaid in a region of importance as opaque content, if the importance metric is related to a region of importance with low value to the subject matter. An importance metric, which is related to a region of importance with medium value to the subject matter, can allow content (130, 230) to be overlaid in the region of importance as transparent content. As previously presented above, an importance metric can prevent any content (130, 230) to be overlaid in a region of importance, if the importance metric is related to a region of importance with high value to the subject matter.

In one embodiment, as shown at 430 of process 400 and in FIG. 1C and FIG. 2C, an importance metric is coupled to at least one region in the video stream such that the value can be utilized to generate placement information for content (130, 230) to be overlaid on the video stream which produces image (160, 260). In accordance with an embodiment of the present invention, the value is coupled to the video stream by embedding an importance metric, which is related to a value corresponding to the subject matter in a video stream. In accordance with another embodiment of the present invention, the value is coupled to the video stream by coupling a meta-data stream containing an importance metric, which is related to a value corresponding to the subject matter, to a video stream. In accordance with an embodiment of the present invention, the importance metric of at least one region of the video stream is transmitted to a user of the video stream.

In one embodiment, as shown at 440 and in FIG. 1C and FIG. 2C, placement information for content to be overlaid on a video stream is used to place content (130, 230) on a video stream which produces image (160, 260).

In one embodiment, as shown at 450 and in FIG. 1C and FIG. 2C, content (130, 230) is displayed in image (160, 260), produced by a video stream, in accordance with generated placement information and an importance metric, which is related to a value corresponding to the subject matter in a video stream. A method for providing placement information for content to be overlaid on a video stream is complete.

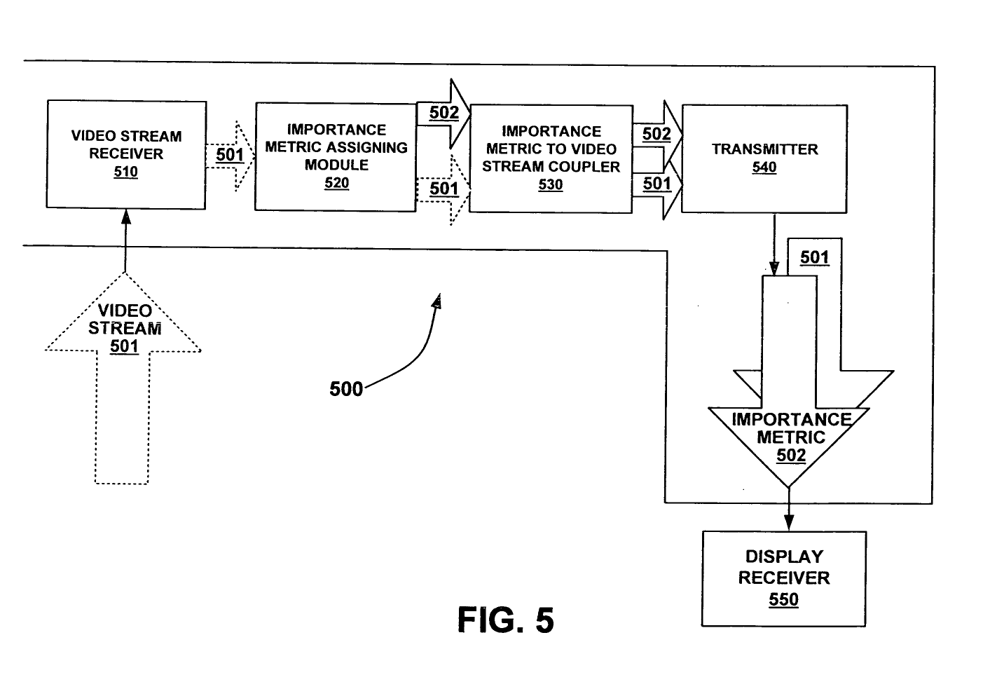

FIG. 5 is block diagram illustrating system 500 for providing placement information for content to be overlaid on a video stream, in accordance with an embodiment of the present invention. System 500 comprises a video stream receiver 510 for receiving a video stream comprising subject matter; an importance metric assigning module 520 for assigning an importance metric of at least one region in the video stream with regards to a value of the subject matter; an importance metric to video stream coupler 530 for coupling importance metric 502 of the at least one region, such that importance metric 502 is compatible with the video stream; and transmitter 540 for transmitting importance metric 502 of the at least one region, wherein the importance metric is configured for providing placement information to a user of the video stream for content to be overlaid by the user. System 500 further comprises display receiver 550.

System 500 will be described with reference to elements shown in FIG. 1B, FIG. 1C, FIG. 2B, and FIG. 2C.

In one embodiment, video stream receiver 510 receives video stream 501. Video stream receiver 510 is any number of means that are operable to receiving a video stream such as, a receiver coupled to a client device, a TCP receiver configured to receive a video stream over the Internet or an intranet, a WiFi receiver, and the like. In accordance with an embodiment of the present invention, video stream receiver 510 is also any physical receiving means of a storage media such as, a floppy disk, a jump drive, a hard disk drive, a recording tape, and the like. Video stream 501 is received by receiver 510 from a number of sources such as, a news team documenting an event, a citizen submitting a personal video from a video camera and a cell phone camera, and a surveillance camera. Video stream 501 is received by receiver 510 with subject matter as the primary content in the video stream and may have some graphics or text included, which is relevant to the content and/or the source of the video stream.

In one embodiment, importance metric assigning module 520 assigns importance metric 502. With reference to FIG. 1B and FIG. 2B importance metric 502 is related to the value corresponding to subject matter in regions of importance (150, 155, 250, 252, 254, 255). Importance metric assigning module 520 assigns an appropriate importance metric 502, such as never allow obstruction of subject matter by content to be overlaid in regions of importance (150, 155, 250, 252, 254). Another example of an appropriate importance metric 502 that importance-metric assigning module 520 may assign is allow occasional obstruction by content to be overlaid in regions of importance 255. The importance metric 502 of “occasional obstruction” may take the form of occasionally moving into exemplary region 255, or allowing content to be overlaid as transparent content. Another example of an appropriate importance metric 502 that importance metric assigning module 520 may assign is allow obstruction by content to be overlaid outside regions of importance (150, 155, 250, 252, 254, 255).

In accordance with an embodiment of the present invention assigning an importance metric of at least one region in a video stream with regards to a value of a subject matter, comprises assigning an importance metric to some block of frames of the video stream. In this manner content to be overlaid will change location smoothly from one region of importance to the next, as the region of importance changes or moves from frame to frame. An example that can benefit from this embodiment is a video stream of a sporting event involving fast action and changing camera angles, such as a basketball game. It is in the best interest of the broadcaster and the viewing audience that the subject matter of the basketball game in the video stream should not be blocked by content to be overlaid, such as scores of other basketball. As the video stream of the basketball game changes in frames that are close ups of players, the ball, overviews of the game, and shots at the basket, it enhances the entertainment value of the game if the scores of other basketball games are for the most part change infrequently from one location and do not move with every change in the video stream.

In one embodiment, importance metric to video stream coupler 530 couples importance metric 502 to video stream 501. In accordance with an embodiment of the present invention, metric to video stream coupler 530 couples importance metric 502 to video stream 501 by embedding importance metric 502, which is related to a value corresponding to the subject matter in video stream 501. In accordance with another embodiment of the present invention, metric to video stream coupler 530 couples importance metric 502 to video stream 501 by coupling a meta-data stream containing importance metric 502, which is related to a value corresponding to the subject matter, to video stream 501.

In one embodiment, transmitter 540 transmits importance metric 502 coupled to video stream 501. Transmitter 540 is any number of means that are operable to transmitting a video stream such as, a transmitter coupled to a server device, a TCP transmitter configured to transmit a video stream over the Internet or an intranet, a WiFi transmitter, and the like. In accordance with an embodiment of the present invention, video stream transmitter 540 is also any physical delivery means for a storage media such as, a floppy disk, a jump drive, a hard disk drive, a recording tape, and the like.

In accordance with an embodiment of the present invention system 500 further comprises display receiver 550. Display receiver 550 receives importance metric 502 coupled to video stream 501 from transmitter 540 Display receiver 510 is operable for displaying user content (130, 230) to be overlaid simultaneously with video stream 501 while overtly displaying important content of video stream 501.

Various embodiments of the present invention provide a method for providing placement information for content to be overlaid on a video stream. The method allows for receiving a video stream and assigning an importance metric to regions of the video stream, such that a broadcaster can use the importance metric to place content to be overlaid by the broadcaster. In so doing the creator and/or owner of the subject matter in the video stream can prevent the value of their video stream from being degraded by overlaid content that obscures an important region of their subject content. The broadcaster increases that value of the video stream by overlaying content of local interest, while preserving the value of the video stream being broadcast.

It is understood that the various embodiments of the present invention are not limited to a broadcast video stream, but include and are not limited to video on-demand, a video stream down-loaded to a computer, a video stream contained on a DVD or CD, and the like.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for providing placement information for content to be overlaid on a video stream, said method comprising:
receiving said video stream, wherein said video stream comprises subject matter;
receiving a value corresponding to said subject matter in said video stream; and
coupling said value with said video stream such that said value can be utilized to generate placement information for said content to be overlaid on said video stream.

2. The method as recited in claim 1 further comprising:
assigning an importance metric to at least one region in said video stream, said importance metric related to said value corresponding to said subject matter.

3. The method as recited in claim 1 wherein said receiving said video stream comprises:
receiving network video content.

4. The method as recited in claim 1 wherein said receiving said video stream comprises:
receiving video gaming content.

5. The method as recited in claim 2 wherein said coupling said value with said video stream comprises:
embedding said importance metric, which is related to said value corresponding to said subject matter, in said video stream.

6. The method as recited in claim 2 wherein said coupling said value with said video stream comprises:
sending a meta-data stream containing said importance metric, which is related to said value corresponding to said subject matter, in said video stream.

7. The method as recited in claim 2 further comprising:
utilizing said importance metric to place said content to be overlaid on a video stream; and
displaying said content to be overlaid on a video stream with said subject matter in accordance with said generated placement information and said importance metric, which is related to said value corresponding to said subject matter, in said video stream.

8. A computer-readable memory containing executable instructions wherein said instructions when executed effect a method for providing placement information for content to be overlaid on a video stream, said method comprising:
receiving said video stream, wherein said video stream comprises subject matter;
assigning an importance metric to at least one region in said video stream, said importance metric, which is related to a value corresponding to an importance of said subject matter, in said video stream; and
coupling said importance metric of said at least one region of said video stream.

9. The computer readable memory as described in claim 8 wherein said assigning said importance of said at least one region comprises:
assigning said importance metric to some block of frames of said video stream.

10. The computer readable memory as described in claim 8 wherein said coupling said importance metric of said at least one region of said video stream comprises:
embedding said importance metric, which is related to said value corresponding to an importance of said subject matter, in said video stream, to said video stream.

11. The computer readable memory as described in claim 8 wherein said coupling said importance metric of said at least one region of said video stream comprises:
coupling a meta-data stream containing said importance metric, which is related to said value corresponding to said subject matter in said video stream, to said video stream.

12. The computer readable memory as described in claim 8 further comprising:
transmitting said importance metric of said at least one region of said video stream to a user of said video stream.

13. The computer readable memory as described in claim 8 further comprising:
utilizing said importance metric to place said content to be overlaid on a video stream; and
displaying said content to be overlaid on a video stream with said subject matter in accordance with said generated placement information and said importance metric, which is related to said value corresponding to said subject matter, in said video stream.

14. A video stream transmission system comprising:
a video stream receiver for receiving a video stream comprising subject matter;
an assigning module for assigning an importance metric of at least one region in said video stream with regards to a value of said subject matter;
a video stream and importance metric coupler for coupling said importance metric of said at least one region, such that said importance metric is compatible with said video stream; and
a transmitter for transmitting said importance metric of said at least one region, wherein said importance metric is configured for providing placement information to a user of said video stream for content to be overlaid by said user.

15. The video stream transmission system of claim 14 wherein said assigning said importance metric of at least one region in said video stream with regards to a value of said subject matter comprises:
assigning said importance metric to some block of frames of said video stream.

16. The video stream transmission system of claim 14 wherein said video stream and importance metric coupler for coupling said importance metric of said at least one region comprises to said video stream comprises:
embedding said importance metric regarding said value corresponding to an importance of said subject matter in said video stream.

17. The video stream transmission system of claim 14 wherein said video stream and importance metric coupler for coupling said importance metric of said at least one region comprises:
coupling a meta-data stream containing said importance metric regarding said value corresponding to an importance of said subject matter, to said video stream.

18. The video stream transmission system of claim 14 further comprising:
a receiver for displaying user content to be overlaid simultaneously with said video stream while overtly displaying important content of said video stream.

19. The video stream transmission system of claim 14 wherein said subject matter comprises:
network video content.

20. The video stream transmission system of claim 14 wherein said subject matter comprises:
video game content.
